(19) United States
(12) Patent Application Publication
(10) Pub. No.: US 2025/0194136 A1
(43) Pub. Date: Jun. 12, 2025

(54) Nanomodular Fabrication of Integrated Circuits

(71) Applicant: Georgia Tech Research Corporation, Atlanta, GA (US)

(72) Inventors: Michael A. Filler, Atlanta, GA (US); Victor Breedveld, Atlanta, GA (US); Eric Vogel, Atlanta, GA (US)

(21) Appl. No.: 18/849,439

(22) PCT Filed: Mar. 22, 2023
(86) PCT No.: PCT/US2023/064811

§ 371 Date: Sep. 20, 2024

Related U.S. Application Data
(60) Provisional application No. 63/269,720, filed on Mar. 22, 2022.

(51) Int. Cl. H10D 30/01; H10D 89/10

(52) U.S. Cl. CPC H10D 30/031; H10D 89/10

(57) ABSTRACT

The present disclosure provides a method of fabricating a nanomodular circuit, the method can comprise: providing a plurality of circuit components; placing the plurality of nanomodular circuit components on a substrate; determining a map of the plurality of nanomodular circuit components on the substrate; determining one or more of routes and connection points to the plurality of nanomodular circuit components for a plurality of electrical interconnects based on the map and a desired function for the circuit; and connecting the plurality of circuit components with the plurality of electrical interconnects at the determined routes and connection points.

### CROSS REFERENCE TO RELATED APPLICATIONS

This application claims the benefit of U.S. Provisional Application Ser. No. 63/269,720, filed on 22 Mar. 2022, which is incorporated herein by reference in its entirety as if fully set forth below

### FIELD OF INVENTION

The various embodiments of the present disclosure relate generally to methods of fabricating integrated circuits.

### BACKGROUND

The on-demand manufacturing of integrated circuits (ICs), akin to the revolution taking place in 3-D printing, promises mass customization, orders-of-magnitude reductions in cycle time and cost, and entirely new use cases. A viable on-demand technology demands a simple end-user experience without unnecessarily sacrificing the performance offered by conventional Si wafer-based technology. Unfortunately, such a marriage of technical attributes is not possible today.

Today, cycle times for custom ICs are on the order of months and cycle costs range from tens of thousands to several million dollars. Such long times, high costs, and, relatedly, the centralization of manufacturing largely result from the fully integrated (i.e., non-modular) nature of the 60-year-old planar process. New ICs start as blank substrates (i.e., Si wafers) and each circuit component is built from the ground up, in a linear, time-consuming sequence. Because all process steps occur on-substrate, the planar process also demands per step yields near 100%, forcing the use of pristine and thus costly processing environments and consumables. These and other aspects (e.g., nonrecurring engineering costs due to photolithography masks) place a floor on IC cycle time and cost.

To date, two main approaches have been pursued in an attempt to enable on-demand IC manufacturing. The fully “integrated” approach aims to use conventional fabrication methodologies, but on a much smaller manufacturing scale. A key benefit of this approach is the high carrier mobility of silicon and the ability to achieve small feature sizes via photolithography. However, its limitations include: (i) distinct mask sets for every circuit design, (ii) difficulty heterogeneously integrating alternative materials, and (iii) a high cost of ownership. Solution processable “modular materials,” such as organics and nanocrystals, have also been explored for on-demand IC manufacturing. Modular materials offer far more flexibility in terms of circuit design and materials choice; however, the low mobility of existing materials yields devices with performances far inferior to Si, and the need for several on-substrate processing steps results in an overly complex end-user experience. Perhaps most importantly, both existing approaches retain the central tenets of planar processing—linear, entirely on-substrate circuit fabrication and per step yields near 100%—that are major drivers of manufacturing time and cost.

Accordingly, there is a need for improved methods for circuit fabrication.

### SUMMARY

An exemplary embodiment of the present disclosure provides a method of fabricating a circuit, the method can comprise: providing a plurality of circuit components; placing the plurality of circuit components on a substrate; determining a map of the plurality of circuit components on the substrate; determining one or more of routes and connection points to the plurality of circuit components for a plurality of electrical interconnects based on the map and a desired function for the circuit; and connecting the plurality of circuit components with the plurality of electrical interconnects at the determined routes and connection points.

In any of the embodiments disclosed herein, the plurality of circuit components may comprise transistors.

In any of the embodiments disclosed herein, the plurality of circuit components may comprise diodes.

In any of the embodiments disclosed herein, the plurality of circuit components may comprise sensors.

In any of the embodiments disclosed herein, the plurality of circuit components may comprise memory devices.

In any of the embodiments disclosed herein, the plurality of circuit components may comprise electromechanical devices.

In any of the embodiments disclosed herein, the plurality of circuit components may comprise logic gates.

In any of the embodiments disclosed herein, each of the plurality of circuit components may have a maximum length, width or height of less than 10 microns.

In any of the embodiments disclosed herein, each of the plurality of circuit components may have a maximum length, width, or height of less than 5 microns

In any of the embodiments disclosed herein, each of the plurality of circuit components may have a maximum length, width, or height of less than 1 micron.

In any of the embodiments disclosed herein, providing the plurality of circuit components may comprise synthesizing the plurality of circuit components and placing the plurality of circuit components within one of a suspension, a dispersion, and a colloid.

In any of the embodiments disclosed herein, wherein placing the plurality of circuit components on the substrate may comprise depositing one of a suspension, a dispersion, and a colloid containing the plurality of circuit components to the substrate.

In any of the embodiments disclosed herein, placing the plurality of circuit components on the substrate may comprise placing the plurality of circuit components at random locations on the substrate.

In any of the embodiments disclosed herein, placing the plurality of circuit components on the substrate may comprise placing the plurality of circuit components at predetermined locations on the substrate.

In any of the embodiments disclosed herein, placing the plurality of circuit components on the substrate may comprise placing the plurality of circuit components with a distribution of positions with a predetermined average spacing between adjacent components on the substrate.

In any of the embodiments disclosed herein, placing the plurality of circuit components on the substrate comprises placing the plurality of circuit components on the substrate at a predetermined average angle with respect to a reference line.

In any of the embodiments disclosed herein, the substrate may be configured to facilitate positioning, alignment, and/or orientation of the plurality of circuit components when the plurality of components are placed onto the substrate.

In any of the embodiments disclosed herein, determining a map of the plurality of circuit components on the substrate may comprise imaging the plurality of circuit components on the substrate.

In any of the embodiments disclosed herein, determining a map of the plurality of circuit components can identify the types of each of the plurality of circuit components. In any of the embodiments disclosed herein, determining a map of the plurality of circuit components identifies defective circuit components in the plurality of circuit components.

In any of the embodiments disclosed herein, determining one or more of routes and connection points to the plurality of circuit components for a plurality of electrical interconnects employs a machine learning algorithm

In any of the embodiments disclosed herein, connecting the plurality of circuit components with the plurality of interconnects at the determined connection points comprises printing the plurality of interconnects on the substrate.

In any of the embodiments disclosed herein, wherein connecting the plurality of circuit components with the plurality of electrical interconnects at the determined connection points may be performed, at least in part, with a photoresist.

In any of the embodiments disclosed herein, wherein connecting the plurality of circuit components with the plurality of interconnects at the determined connection points may comprise applying a metallic ink to the substrate

In any of the embodiments disclosed herein, wherein placing the plurality of circuit components on the substrate and connecting the plurality of circuit components with the plurality of interconnects at the determined connection points, may occurs at a temperature between about 25° C. and about 200° C.

In any of the embodiments disclosed herein, wherein determining a position of the plurality of circuit components on the substrate may comprise determining an angle of each of the plurality of circuit components on the substrate with respect to a reference line.

In any of the embodiments disclosed herein, determining a position of the plurality of circuit components on the substrate comprises determining one or more dimensions of each of the plurality of circuit components on the substrate.

In any of the embodiments disclosed herein, the plurality of circuit components may be nanomodular circuit components. The nanomodular circuit components may be discrete electronic circuit components, wherein all structures used for the electrical operation upon subsequent electrical interconnection into the nanomodular circuit may be prefabricated

In any of the embodiments disclosed herein, the nanomodular circuit components may have a maximum length, width, or height of less than 25 microns. The nanomodular circuit components may have a maximum length, width, or height of less than 10 microns. The nanomodular circuit components may have a maximum length, width, or height of less than 5 microns. The nanomodular circuit components have a maximum length, width, or height of less than 1 micron. The nanomodular circuit components may comprise MOSFETS and silicon MOSFETS, wherein the MOSFETS may comprise a gate dielectric and a gate metal.

Another exemplary embodiment of the present disclosure provides a method for manufacturing a nanomodular circuit, the method may comprise: synthesizing a plurality of nanomodular components; placing the plurality of nanomodular components on a substrate; creating a nanomodular component layout of the plurality of nanomodular components on the substrate; identifying one or more electrical routes and connection points to the plurality of nanomodular components for a plurality of electrical interconnects based on the nanomodular component layout to achieve a nanomodular circuit schematic detailing a designed nanomodular circuit output; and linking the plurality of nanomodular components with the plurality of electrical interconnects at the identified electrical routes and connection points.

In any of the embodiments disclosed herein, the plurality of nanomodular components may comprises at least one member from the group comprising: transistors, diodes, sensors, memory devices, electromechanical devices, MOSFETs, or logic gates. The MOSFETS may comprise a gate dielectric, a gate metal, source electrodes, and gate electrodes.

In any of the embodiments disclosed herein, synthesizing the plurality of nanomodular components may comprise storing the plurality of nanomodular components within one of a suspension, a dispersion, and a colloid.

In any of the embodiments disclosed herein, the nanomodular components can be discrete electronic circuit components, wherein all structures used for the electrical operation upon subsequent electrical interconnection into the nanomodular circuit are prefabricated.

In any of the embodiments disclosed herein, placing the plurality of nanomodular components on a substrate may comprise placing the plurality of nanomodular components at predetermined locations on the substrate. The substrate can be configured to receive the plurality of nanomodular components.

In any of the embodiments disclosed herein, placing the plurality of nanomodular components on the substrate comprises positing one of a suspension, a dispersion, or a colloid onto the substrate in a desired configuration. The desired configuration can be a random arrangement of the plurality of nanomodular components on the substrate

In any of the embodiments disclosed herein, placing the plurality of nanomodular components on a substrate configured to receive the plurality of nanomodular components can comprise placing the plurality of nanomodular components with a distribution of positions with a predetermined average spacing between adjacent components on the substrate.

In any of the embodiments disclosed herein, wherein placing the plurality of nanomodular components on a substrate configured to receive the plurality of nanomodular components comprises placing the plurality of nanomodular components on the substrate at a predetermined average angle with respect to a reference line.

In any of the embodiments disclosed herein, wherein creating a nanomodular component layout of the plurality of nanomodular components on the substrate may comprise: imaging the plurality of nanomodular component on the substrate; ascertaining the identity of the types of each of the nanomodular components; and detecting defective components in the plurality of nanomodular components.

In any of the embodiments disclosed herein, wherein identifying one or more electrical routes and connection points to the plurality of nanomodular components for a plurality of electrical interconnects based on the nanomodular component layout to achieve a nanomodular circuit schematic detailing a designed nanomodular circuit output may employ a machine learning algorithm.

In any of the embodiments disclosed herein, wherein creating a nanomodular component layout of the plurality of nanomodular components comprises identifying one or more measurements for each of the plurality of nanomodular components on the substrate.

In any of the embodiments disclosed herein, wherein placing the plurality of nanomodular components on the substrate and linking the plurality of nanomodular components with the plurality of electrical interconnects at the identified electrical routes and connection points may comprise applying a temperature between about 25° C. and about 200° C.

In any of the embodiments disclosed herein, the nanomodular components may have a maximum length, width, or height of less than 25 microns. The nanomodular components may have a maximum length, width, or height of less than 10 microns. The nanomodular components may have a maximum length width, or height of less than 5 microns. The nanomodular components may have a maximum length width, or height of less than 5 microns. The nanomodular components may have a maximum length width, or height of less than 1 microns.

In any of the embodiments disclosed herein, linking the plurality of nanomodular components with the plurality of electrical interconnects at the identified electrical routes and connection points may comprise applying a metallic ink to the substrate.

In any of the embodiments disclosed herein, linking the plurality of nanomodular components with the plurality of electrical interconnects at the identified electrical routes and connection points may be executed, at least in part, by using a photoresist.

In any of the embodiments disclosed herein, linking the plurality of nanomodular components with the plurality of electrical interconnects at the identified electrical routes and connection points may comprise printing the plurality of electrical interconnects on the substrate.

In any of the embodiments disclosed herein, the substrate may comprise a non-planar surface. The substrate may comprise glass. The substrate may comprise plastic. The substrate may comprise paper.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF DRAWINGS

The above and further aspects of this invention are further discussed with reference to the following description in conjunction with the accompanying drawings, in which like numerals indicate like structural elements and features in various figures. The drawings are not necessarily to scale, emphasis instead being placed upon illustrating principles of the invention. The figures depict one or more implementations of the inventive devices, by way of example only, not by way of limitation.

FIG. 1 is an illustration of an exemplary process for the fabrication of nanomodular circuits and nanomodular components according to aspects of the present disclosure.

FIG. 2 is an illustration of an exemplary process for the fabrication of a nanomodular component according to aspects of the present disclosure.

FIG. 3 provides a method flow chart of example processes for fabricating nanomodular circuits and components according to aspects of the present disclosure.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

By “comprising” or “containing” or “including” is meant that at least the named compound, element, particle, or method step is present in the composition or article or method, but does not exclude the presence of other compounds, materials, particles, method steps, even if other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

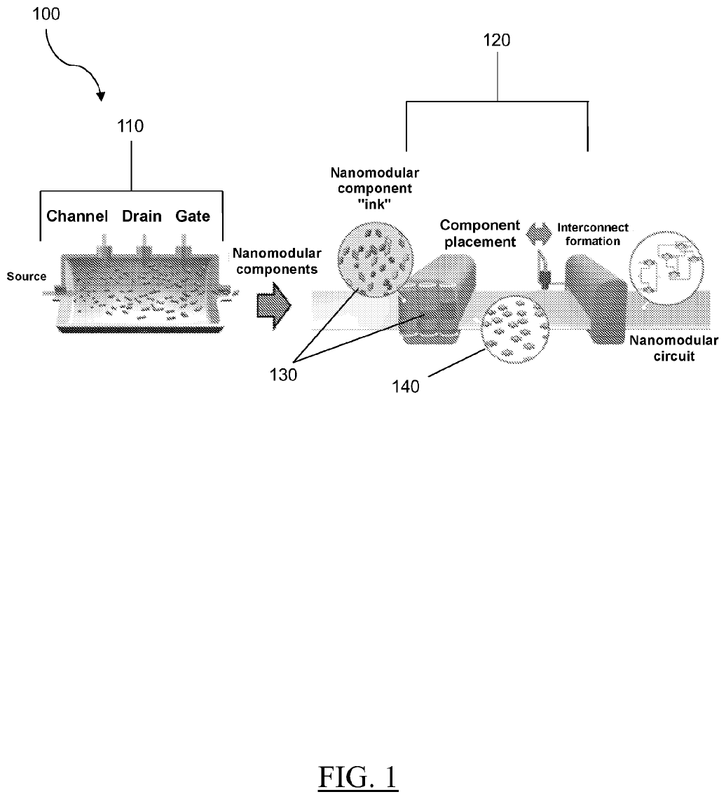

Disclosed herein are methods needed to produce nanomodular integrated circuits (NM-ICs). As one skilled in the art will appreciate, integrated circuits (ICs) are electronic circuits where electronic components, when arranged and interconnected in specific ways, may achieve various output behaviors. ICs may contain electronic components on the order of nanometers or micrometers. FIG. 1 provides an illustration of an exemplary NM-IC manufacturing process 100. As shown in FIG. 1, NM-ICs factor component fabrication and circuit manufacturing, which is advantageous as it can offer an unprecedented combination of electronic performance and functionality as well as end-user ease-of-use. The process takes place in two sets of steps: a nanomodular component fabrication step 110 and a component interconnection step 120.

A nanomodular component contains all the features needed for its subsequent operation and electrical interconnection into a nanomodular circuit. In the case of nanomodular metal-oxide-semiconductor field effect transistors (MOSFETs), the components comprise features such as a low defect density gate stack and low resistance source/drain contacts. Prefabrication of these features can be advantageous in creating NM-ICs as it enables subsequent interconnection at low temperature with less toxic chemicals. As one skilled in the art will appreciate, nanomodular components 140 can include a plethora of circuit components. In some embodiments, nanomodular components 140 can include but not be limited to transistors, diodes, sensors, memory devices, electromechanical devices, MOSFETs, logic gates, and the like. In some embodiments, with respect to the present disclosure, the nanomodular components 140 can have a maximum length, width, or height of less than 25, 10, 5, or 1 micron. Nanomodular components 140 may be fabricated using bottom-up and/or top-down methods and can be comprised of any materials required for their function, including semiconductors, dielectrics, and metals.

Nanomodular components 140 can be formulated into nanomodular “component inks” 130. In some embodiments, these inks 130 may be one of a suspension, a dispersion, or a colloid, containing one or more nanomodular components 140. The nanomodular components 140 may remain within the inks 130 prior to being transported to a substrate. As one skilled in the art will also appreciate, substrates can be rigid or flexible, with flexible substrates allowing the circuit to conform to desired shapes for a specific design purpose. With respect to the present disclosure, the substrate can include a non-planar surface, glass, plastic, paper and the like. Once fabricated and formulated as a component ink, the nanomodular components 140 may be posited onto the substrate as part of the component interconnection step 120 within the NM-IC process 100.

As shown in FIG. 1, nanomodular components 140 may be connected during the nanomodular component interconnection step 120 to form NM-ICs. In some embodiments, the nanomodular component interconnection step 120 can be performed at least in part by an automated NM-IC circuit manufacturing tool. The NM-IC manufacturing tool can place, map, and adaptively interconnect nanomodular components 140 as shown in FIG. 1. In some embodiments, a nanomodular component layout can be posited onto the substrate, which can be acquired and sent to a custom electronic design automation (EDA) software for circuit routing based on the map and a specified nanomodular circuit functionality. As opposed to nanomodular component fabrication step 110, which likely requires high temperatures and toxic chemicals, nanomodular component interconnection can be accomplished at relatively lower temperatures, using relatively non-toxic consumables. In some embodiments, placing the plurality of nanomodular components 140 on the substrate and thereby linking the plurality of nanomodular components 140 on the substrate can be accomplished through applying a temperature between about 25° C. and about 200° C.

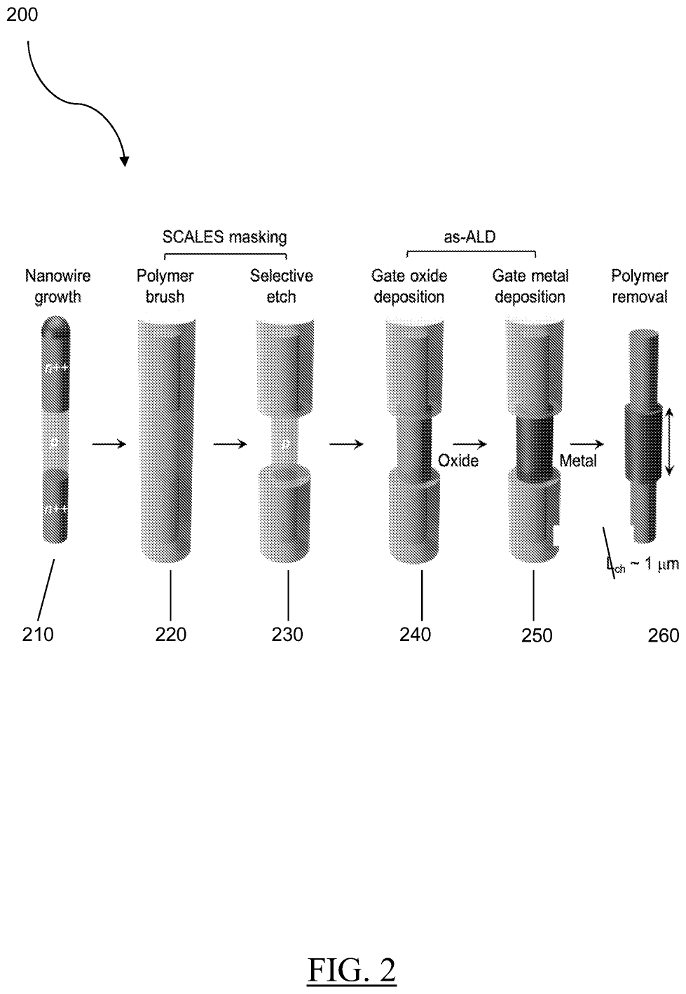

FIG. 2, for example, provides an illustration of an exemplary process for the fabrication of a nanomodular Si MOSFET component according to aspects of the present disclosure. As discussed previously, nanomodular components 140 can be manufactured using bottom up fabrication techniques. In the case of nanomodular MOSFETs fabricated in this manner, single-crystal Si nanowires with n⁺⁺-p-n⁺⁺ dopant profiles can be grown with the vapor-liquid-solid (VLS) mechanism, as shown in step 210 of FIG. 2. In some embodiments, the length and dopant concentration of each segment 212, as shown in step 210 can be readily controlled by changing precursor concentrations and growth time, so that nanomodular MOSFET dimensions can be tuned to achieve performance goals and facilitate contacting/interconnect printing. Once the nanowires are grown, gate stack formation can be achieved through combining the SCALES (Selective CoAxial Lithography via Etching of Surfaces) patterning process with the area selective ALD (as-ALD) of oxide and metal thin films. As one skilled in the art will appreciate, the SCALES process, shown as steps 220 and 230 in FIG. 2, is a unique and enabling process that can leverage the dopant encoding of the nanowires, a surface grafted polymer film, and a selective etchant to create conformal nanoscale masks on the nanowire surface. The SCALES process begins by growing a covalently tethered polymer brush, such as polymethylmethacrylate (PMMA), from the surface of a dopant-encoded Si nanowire using a technique such as atom transfer radical polymerization (ATRP). Selective polymer removal from the lightly doped Si channel region is accomplished with a selective etchant such as KOH. Once completed, the polymer mask will then direct the deposition of a gate dielectric using a technique such as ALD, which is shown in steps 240 and 250 of FIG. 2. In some embodiments, gate dielectrics can include compounds including but not limited to HfO₂, ZrO₂, and the like. As one skilled in the art will appreciate, ALD is known as atomic layer deposition and includes the process of exposing the surface of the substrate to a sequence of precursors that places a film layer by layer. To complete bottom up fabrication of the nanomodular MOSFET, deposition of a metal electrode, using a technique such as as-ALD, and final polymer removal are performed as shown in step 260 of FIG. 2. In some embodiments, source and drain electrodes can be added using similar area selective methods. In some embodiments, upon completion of fabrication of the nanomodular MOSFET, the nanomodular MOSFET can be stabilized within a colloidal dispersion awaiting placement on a suitable substrate and interconnection to form a nanomodular circuit.

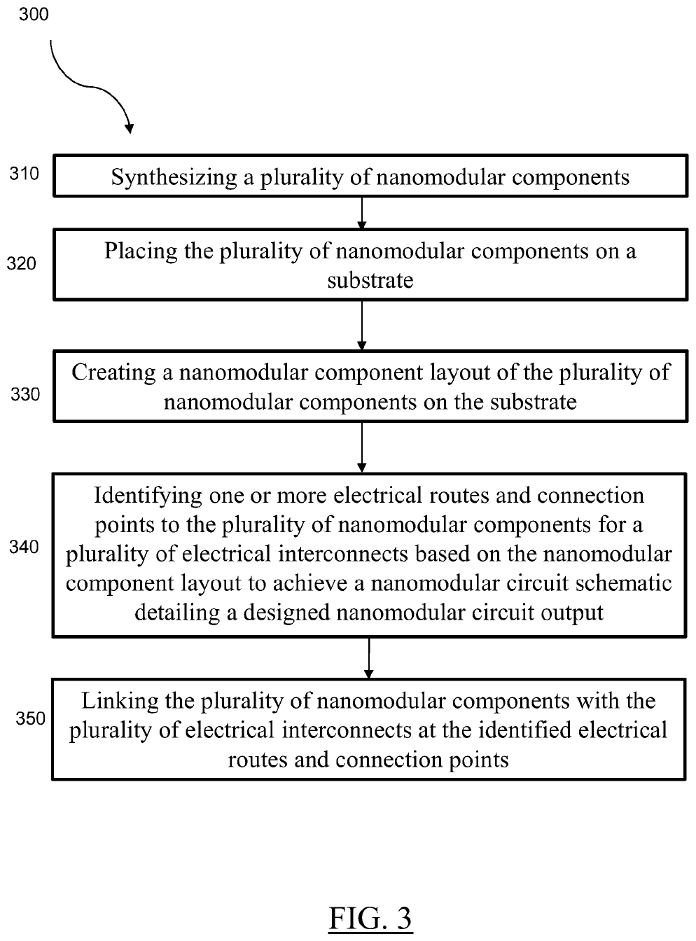

FIG. 3 provides a method flow chart of example processes for fabricating nanomodular circuits and components, in accordance according to aspects of the present disclosure. The method 300 can comprise the method step 310 of synthesizing a plurality of nanomodular components 140. In some embodiments, the method step 310 of synthesizing a plurality of nanomodular components 140 may include storing the plurality of nanomodular components 140 within one of a suspension, a dispersion, and a colloid as shown in FIG. 1. As should be appreciated, the nanomodular components 140 synthesized in method step 310 can be discrete electronic components, wherein all structures used for electrical operation upon subsequent electrical interconnection into the nanomodular circuit may be prefabricated.

The method 300 can further comprise the method step 320 of placing the plurality of nanomodular components 140 on a substrate. As mentioned previously, the nanomodular components 140, once synthesized may be stored within one of a suspension, a dispersion, and a colloid. In some embodiments, placing the plurality of nanomodular components 140 on the substrate comprises positing one of a suspension, a dispersion, or a colloid onto the substrate in a desired configuration, wherein the desired configuration may be a random arrangement of the plurality of nanomodular components 140 on the substrate. Conversely, in some embodiments, placing the plurality of nanomodular components 140 on a substrate may comprise placing the plurality of nanomodular components 140 at predetermined locations on the substrate. In either of the aforementioned embodiments, the substrate can be configured to receive the plurality of nanomodular components 140.

As one skilled in the art will appreciate, placement of circuit components on a substrate can consider various factors such as dimensions of the circuit components, the dimensions of the substrate, desired operation of the electronic circuit, and the like. The method 300 can further comprise method step 330 of creating a nanomodular component layout of the plurality of nanomodular components 140 on the substrate. In some embodiments, creating a nanomodular component layout of the plurality of nanomodular components 140 on the substrate may include imaging the plurality of nanomodular components 140 on the substrate, ascertaining the identity of the types of each of the nanomodular components 140, and detecting defective components in the plurality of nanomodular components 140. Additionally, creating a nanomodular component layout of the plurality of nanomodular components 140 on the substrate may include identifying one or more measurements for each of the plurality of nanomodular components 140 on the substrate. For example, once an end user has placed the plurality of nanomodular components 140 in a desired configuration, the automated NM-IC circuit manufacturing tool may analyze the operational status, identities, and measurements for each of the nanomodular components 140 to create a nanomodular component layout.

The method 300 can further comprise the method step 340 of identifying one or more electrical routes and connection points to the plurality of nanomodular components 140 for a plurality of electrical interconnects based on the nanomodular component layout to achieve a nanomodular circuit schematic detailing a designed nanomodular circuit output. In some embodiments, the automated NM-IC circuit manufacturing tool may identify one or more electrical routes and connection points to the plurality of nanomodular components 140 for a plurality of electrical interconnects through leveraging a machine learning algorithm.

The method 300 can further comprise the method step 350 of linking the plurality of nanomodular components 140 with the plurality of electrical interconnects at the identified electrical routes and connection points. In some embodiments, the plurality of nanomodular components 140 with the plurality of electrical interconnects at the identified electrical routes and connection points is executed, at least in part, by using a photoresist. As one skilled in the art will appreciate, a photoresist is a light-sensitive material used to form a patterned coating on a surface and a tool used in many electronics manufacturing processes. With respect to the present disclosure, the photoresist may be used to define where interconnects will be formed to the plurality of nanomodular interconnects on the substrate at the identified electrical routes and connection points. Interconnects can be (1) single material interconnects, where a single material serves to contact and interconnect nanomodular components as well as (2) multi-material interconnects, where one material contacts the semiconductor and another material serves as the component-to-component interconnect. Insulating material can be used to allow one interconnect to traverse another interconnect without creating an electrical short.

In some embodiments, linking the plurality of nanomodular components 140 with the plurality of electrical interconnects at the identified electrical routes and connection points may comprise printing the plurality of electrical interconnects on the substrate. For example, electrohydrodynamic jet (e-jet) printing is one potential route to nanomodular component contacting and interconnection. As one skilled in the art will appreciate, the electric-field-based mechanism enables sub-micron print resolution in a desktop-sized footprint. At current metal line print speeds (1 mm/sec), assuming a standard device fan-out of 5 and an average device spacing of 10 μm, more than 10,000 nanomodular components 140 can be interconnected in under 10 minutes. While more than adequate for many initial NM-IC applications, improvements to throughput (e.g., 25-50 mm/sec is common for polymers) promise NM-ICs with even larger numbers of components.

The method for manufacturing NM-ICs disclosed herein can allow for the maintenance and extension of development within the electronics industry. For example, nanomodular components 140 and circuits can allow for the heterogeneous integration of most any type of components (e.g., logic, memory, energy harvesting/storage, sensing) or material (e.g., Si, III-V, organic, 2-D). Furthermore, the methods of the present disclosure may reduce the required end-user knowledge to device input/output characteristics as opposed to details about materials or device physics. NM-IC manufacturing tools can become the means of production, eliminating the need for design-specific photolithography masks, and enabling a multitude of designs with the same equipment.

Distributed manufacturing, employed by the method of manufacturing NM-ICs disclosed herein, increases resiliency and improves security by allowing more electronic components to be produced by more manufacturers in more locations. NM-ICs can eliminate the need to stockpile circuits or discard unpurchased, unwanted inventory. Although field-programmable gate arrays (FPGAs) may allow for circuit function to be set after the point of circuit manufacture, the end-user is still limited by the types and number of devices in the FPGA. By modularizing at the component level, end users can make decisions about specific circuit functionalities (and thus designs) to be made on-the-fly as conditions on the ground necessitate.

NM-IC manufacturing tools and methods disclosed herein can allow nanomodular components 140 to be incorporated on or in a range of substrates and materials, respectively; thus, enabling the construction of ICs as thin films on highly curved and flexible surfaces. While such a capability is a central benefit of existing printed electronics, the modularization of high-performance (e.g., single-crystalline) components disclosed herein are distinct as these NM-ICs can provide a unique marriage of form factor and computational capability.

While distributed manufacturing can be an advantage of certain embodiments of the present disclosure, bottom-up device synthesis can be amenable to scale-up and the orders-of-magnitude increase in throughput that would accompany it. The application of parallel assembly techniques could thus open the door to ‘massively-scalable’ electronic systems (e.g., aerosolizable smart dust) that promise additional use cases.

Example use cases for the NM-ICs manufactured using the process disclosed herein can include but not be limited to physical cryptography, personalized bioelectronics, and the like. In the case of hardware-based cryptography, such as physically unclonable functions (PUFs) or random number generators, NM-ICs could enable large numbers of distinct, low-cost, and on-demand NM-ICs. Rather than leveraging random variations during cleanroom manufacturing, and the security limitations they entail, NM-ICs can allow unique circuits to be fabricated for each part. Opportunities can also include securing, validating, and tracking high value components/parts (e.g., avionics), biologics, critical shipments, and the like. To maximize security, circuits could also be manufactured outside of fabs, on/in a variety of substrates, and even on-demand in the field. In the case of personalized bioelectronics, future personalized electronic medicines and prostheses (e.g., human-computer interfaces or retinal implants), due to dependence on an individual's specific biochemistry/anatomy at a given point in time, can also benefit from the unique circuits that can be fabricated through the use of NM-ICs.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. A method comprising:
forming a deposition media of circuit components;
wherein the deposition media of circuit components is configured for fabrication of a circuit comprising the circuit components.

2. The method of claim 1, wherein the forming comprises:
synthesizing the circuit components; and
placing the circuit components within one or more of a suspension, a dispersion, or a colloid.

3. The method of claim 2, wherein the circuit components are selected from a group consisting of transistors, diodes, sensors, memory devices, electromechanical devices, logic gates, and a combination thereof.

4. The method of claim 3, wherein the circuit components are nanomodular circuit components.

5. The method of claim 4, wherein the synthesizing is bottom-up nanomodular circuit component synthesis.

6. The method of claim 1 further comprising:
placing the deposition media of circuit components on a substrate;
determining a map of the circuit components on the substrate;
determining one or more routes and connection points to the circuit components for electrical interconnects based on the map and a desired function for the circuit; and
connecting the circuit components with the electrical interconnects at the determined routes and connection points.

7.-19. (canceled)

20. The method of claim 6, wherein the determining of the map identifies defective circuit components.

21. The method of claim 6, wherein the determining of the one or more routes and connection points employs a machine learning algorithm.

22. (canceled)

23. The method of claim 6, wherein the connecting is performed, at least in part, with a photoresist.

24.-25. (canceled)

26. The method of claim 6, wherein the substrate comprises a non-planar surface.

27.-28. (canceled)

29. The method of claim 6, wherein the substrate comprises paper.

30.-31. (canceled)

32. The method of claim 6, wherein the circuit components are nanomodular circuit components.

33. The method of claim 32, wherein the nanomodular circuit components are discrete electronic circuit components.

34.-37. (canceled)

38. The method of claim 33, wherein the nanomodular circuit components comprise metal-oxide-semiconductor field-effect transistors (MOSFETs).

39. The method of claim 33, wherein the nanomodular circuit components comprise silicon MOSFETs.

40. The method of claim 39, wherein the MOSFETS comprise a gate dielectric and a gate metal.

41. The method of claim 1, wherein:
the circuit components comprise nanomodular components;
the forming comprises:
synthesizing a plurality of the nanomodular components; and
storing the plurality of nanomodular components within one of a suspension, a dispersion, and a colloid; and
the method further comprises:
placing the plurality of nanomodular components on a substrate;
creating a nanomodular component layout of the plurality of nanomodular components on the substrate;
identifying one or more electrical routes and connection points to the plurality of nanomodular components for a plurality of electrical interconnects based on the nanomodular component layout to achieve a nanomodular circuit schematic detailing a designed nanomodular circuit output; and
linking the plurality of nanomodular components with the plurality of electrical interconnects at the identified electrical routes and connection points.

42. The method of claim 41, wherein the plurality of nanomodular components comprises at least one member from the group comprising: transistors, diodes, sensors, memory devices, electromechanical devices, MOSFETs, or logic gates.

43.-45. (canceled)

46. The method of claim 41, wherein the nanomodular components are discrete electronic circuit components; and
wherein all structures used for the electrical operation upon subsequent electrical interconnection into the nanomodular circuit are prefabricated.

47. The method of claim 41, wherein placing the plurality of nanomodular components on the substrate comprises at least one of:
placing the plurality of nanomodular components at predetermined locations on the substrate;
placing the plurality of nanomodular components with a distribution of positions with a predetermined average spacing between adjacent components on the substrate;
placing the plurality of nanomodular components on the substrate at a predetermined average angle with respect to a reference line; or
positing the deposition media onto the substrate in a desired configuration.

48.-52. (canceled)

53. The method of claim 41, wherein the creating comprises at least one of:
(i) identifying one or more measurements for each of the plurality of nanomodular components on the substrate; or
(ii) imaging the plurality of nanomodular component on the substrate;
ascertaining an identity of a type of each of the nanomodular components; and
detecting defective components in the plurality of nanomodular components.

54.-55. (canceled)

56. The method of claim 41, wherein the placing the plurality of nanomodular components on the substrate and the linking the plurality of nanomodular components with the plurality of electrical interconnects at the identified electrical routes and connection points comprises applying a temperature between about 25° C. and about 200° C.

57. The method of claim 41, wherein the nanomodular components have a maximum length, width, or height of less than maximum size selected from a group consisting of 25 microns, 10 microns, 5 microns, and 1 micron.

58.-60. (canceled)

61. The method of claim 41, wherein the linking at least one of:
comprises applying a metallic ink to the substrate;
comprises printing the plurality of electrical interconnects on the substrate; or
is executed, at least in part, by using a photoresist.

62.-63. (canceled)

64. The method of claim 41, wherein the substrate at least one of:
comprises a non-planar surface;
comprises glass;
comprises plastic; or
comprises paper.

65.-67. (canceled)
